(19) United States
(12) Patent Application Publication
(10) Pub. No.: US 2024/0110010 A1
(43) Pub. Date: Apr. 4, 2024

(54) POLYIMIDE POWDER HAVING CONTROLLED PARTICLE SIZE AND METHOD FOR PREPARING SAME

(71) Applicant: PI ADVANCED MATERIALS CO., LTD., Jincheon-gun, Chungcheongbuk-do (KR)

(72) Inventors: Ho Sung LEE, Jincheon-gun, Chungcheongbuk-do (KR); Ik Sang LEE, Jincheon-gun, Chungcheongbuk-do (KR); Jin Seok JEON, Jincheon-gun, Chungcheongbuk-do (KR)

(21) Appl. No.: 18/253,979

(22) PCT Filed: Dec. 28, 2020
(86) PCT No.: PCT/KR2020/019235

§ 371 Date: May 23, 2023

(30) Foreign Application Priority Data
Nov. 30, 2020 (KR) 10-2020-0164750

(51) Int. Cl. C08G 73/10

(52) U.S. Cl. CPC C08G 73/1032; C08G 73/1071; B29K 2105/251

(57) ABSTRACT

The present invention relates to a method for producing a polyimide powder, particularly to a method for producing a polyimide powder, which includes a) preparing a dispersion by dispersing a dianhydride and a diamine in distilled water; and b) introducing the dispersion of step a) into a reactor and conducting the reaction at a stirring speed of 300 rpm or more under temperature and pressure conditions. In the present invention, it is possible to improve physical properties and control the particle size and dispersibility without additional processes by using water-based polymerization and controlling the stirring speed in the production process.

### TECHNICAL FIELD

The present invention relates to a method for producing a polyimide powder having a controlled particle size, more particularly to a technique capable of significantly decreasing the particle size of polyimide powder without deteriorating mechanical properties by controlling the stirring speed in the process of producing a polyimide powder through water-based polymerization.

### BACKGROUND ART

Polymer molding is related to physical treatment for manufacturing molded articles from polymer materials such as plastic and rubber, and refers to a series of processes including both an operation of shaping a polymer material into a predetermined shape by applying conditions such as heat and pressure and an operation of shaping a polymer material in a liquid form without applying heat or pressure. The molding and processing of polymer materials is divided into primary molding (injection, extrusion, blow molding, and the like), secondary molding (thermoforming, bonding, and the like), and the like in terms of stages, and is classified into compression molding, rolling molding, injection molding, vacuum molding, blow molding, foam molding, fiber spinning, and the like in terms of method. In polymer molding, it is required to design an article with certain quality to be price-competitive, various changes occur depending on the conditions such as heat and pressure during the molding process even if the properties of the polymer are known, and it is thus difficult to directly manufacture molded articles having desired properties.

Polyimide generally refers to a highly heat resistant polymer produced by condensation polymerization of a tetracarboxylic acid or a derivative thereof and an aromatic diamine or an aromatic diisocyanate, followed by imidization. In addition, polyimide has insolubility that does not dissolve in solvents and infusibility that does not melt by heating, and may have various molecular structures depending on the kind of monomer used. In general, polyimide is produced through condensation polymerization using pyromellitic dianhydride (PMDA) or biphenyltetracarboxylic dianhydride (BPDA) as an aromatic tetracarboxylic acid derivative component and oxydianiline (ODA) or p-phenylene diamine (p-PDA) as an aromatic diamine component.

Since polyimide has high heat resistance and high strength, various studies are being conducted for use thereof in motor vehicles, aerospace, aviation, electric and electronic parts. Polyimide has insolubility and infusibility due to an imide ring in the repeating unit, so it is common to perform processing in the state of polyamic acid, which is a precursor thereof. Beginning with the wholly aromatic polyimide resin of Du Pont in 1962, polyimide modified or improved in heat resistance, alkali resistance, dimensional stability, low water absorption, and the like, for example, polyamideimide and polyetherimide have been disclosed.

Polyimide resin can be produced by a relatively simple method such as mechanical stirring and thermal imidization of polyimide monomers. However, polyimide resin exhibits greatly poor moldability and processability in the molding process for manufacturing a polyimide molded article, so it difficult to manufacture a molded article of polyimide resin using a general polymer processing machine. As part of an effort to overcome the moldability and processability, attempts have been made to manufacture molded articles using polyimide powder.

Polyimide powder is different from polyimide resin in shape, so it is difficult to apply commonly known molding methods such as heating and melting to polyimide powder. In addition, the manufacture of molded articles using powder is affected by various factors such as the specific surface area, degree of imidization, degree of crystallinity, molecular weight, and particle size of the powder, and the balance among the respective conditions is essential. Therefore, in general, molded articles are manufactured using polyimide resin, and separate studies are required to manufacture molded articles using polyimide powder.

In this regard, U.S. Pat. No. 9,469,048 discloses a polyimide powder produced using a mixture of 3,3′4,4′-biphenyltetracarboxylic dianhydride and pyromellitic dianhydride and a mixture of p-phenylenediamine, m-phenylenediamine, and 4,4′-diaminodiphenyl ether, and a polyimide molded article. U.S. Pat. No. 7,758,781 discloses polyimide fine particles formed by polymerization of an aliphatic diamine and a tetracarboxylic acid, and a molded article manufactured by dry blending and compression molding of the polyimide particles. In addition, Korean Patent No. 1,987,511 discloses a semi-crystalline, semi-aromatic thermoplastic polyimide powder produced using an aliphatic diamine and an aromatic tetracarboxylic acid.

However, despite these efforts, polyimide powder has low dielectric properties, making it difficult to apply polyimide powder to material parts, and still has a problem that it is difficult to mold and process polyimide powder because of low dispersibility and a problem that mechanical properties are deteriorated in the process of solving the problem in molding and processing.

Accordingly, the inventors of the present invention have completed the present invention by finding that when a polyimide powder is produced by controlling the stirring speed in the process of producing the polyimide powder, it has an excellent mechanical strength and a decreased particle size.

### SUMMARY OF INVENTION

### Technical Problem

An object of the present invention is to solve the difficulty of molding an existing polyimide powder by controlling the particle size of polyimide powder without additional processes.

### Solution to Problem

In order to achieve the object, the present invention provides a method for producing a polyimide powder, which includes a) preparing a dispersion by dispersing a dianhydride and a diamine in distilled water; and b) introducing the dispersion of step a) into a reactor and conducting the reaction at a stirring speed of more than 200 rpm under temperature and pressure conditions.

The present invention also provides a polyimide powder produced by the production method.

The present invention also provides a polyimide molded article manufactured by sintering the polyimide powder.

In an aspect of the present invention, the dianhydride in step a) may be a dianhydride represented by the following Chemical Formula 1.

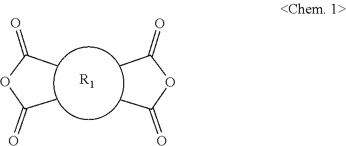

In Chemical Formula 1, R 1 is selected from the group consisting of the following chemical structures

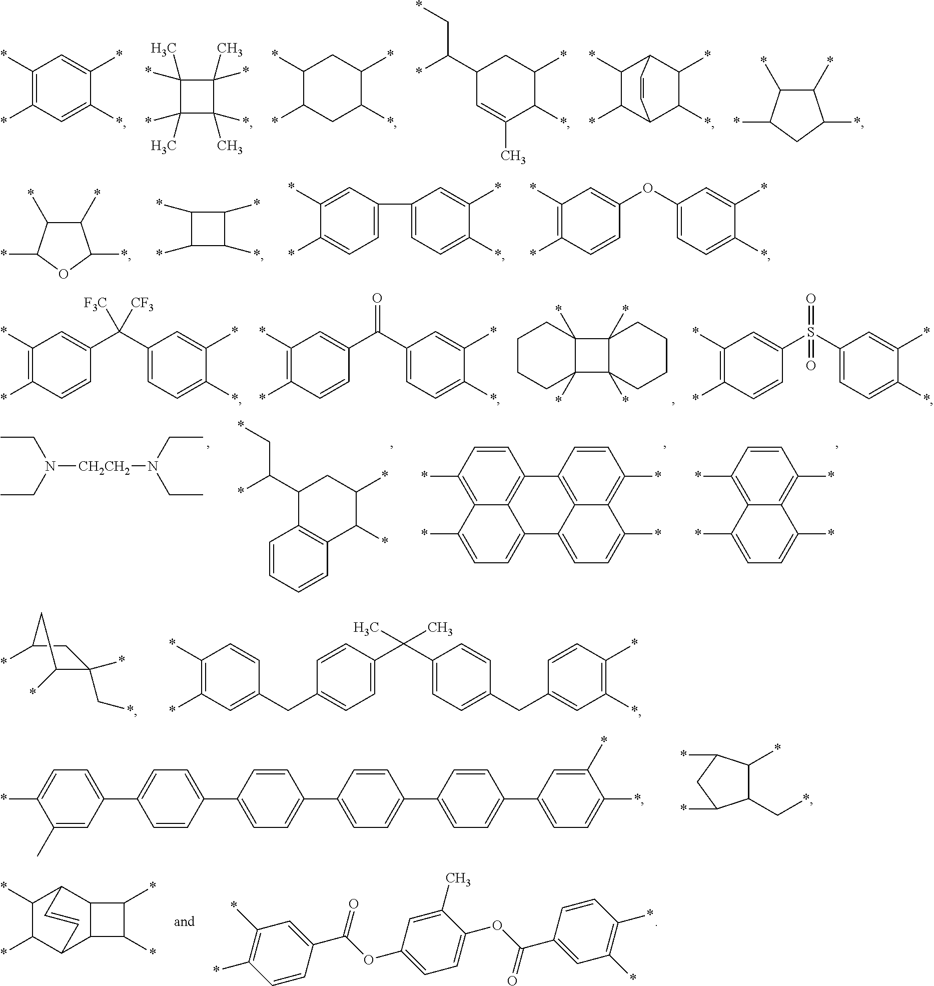

In an aspect of the present invention, the diamine in step a) may be a diamine represented by the following Chemical Formula 2.

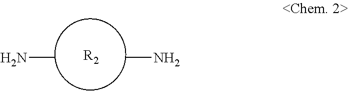

In Chemical Formula 2, R₂ is selected from the group consisting of the following chemical structures

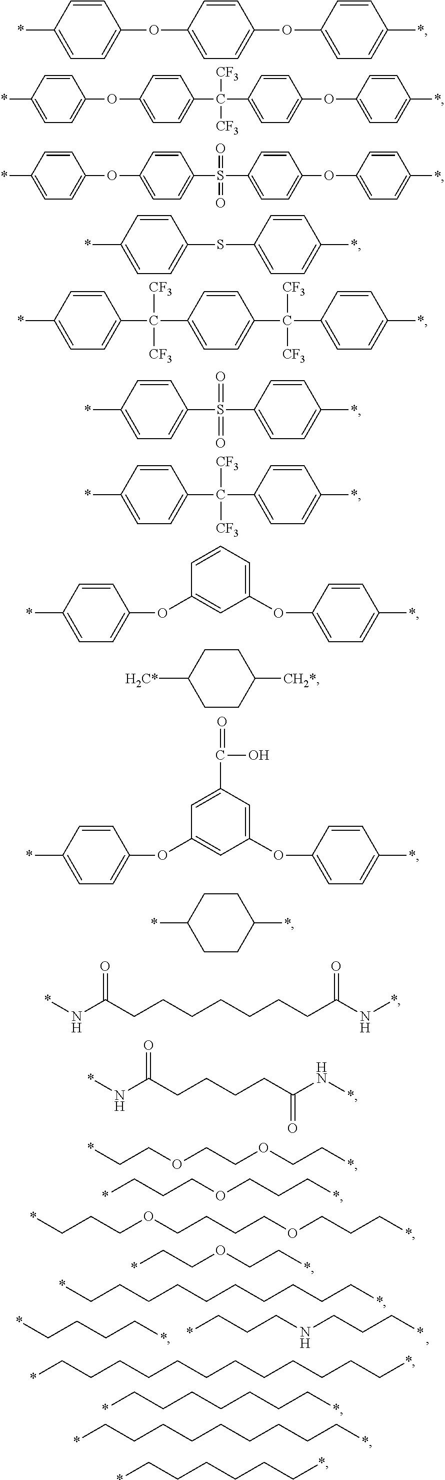

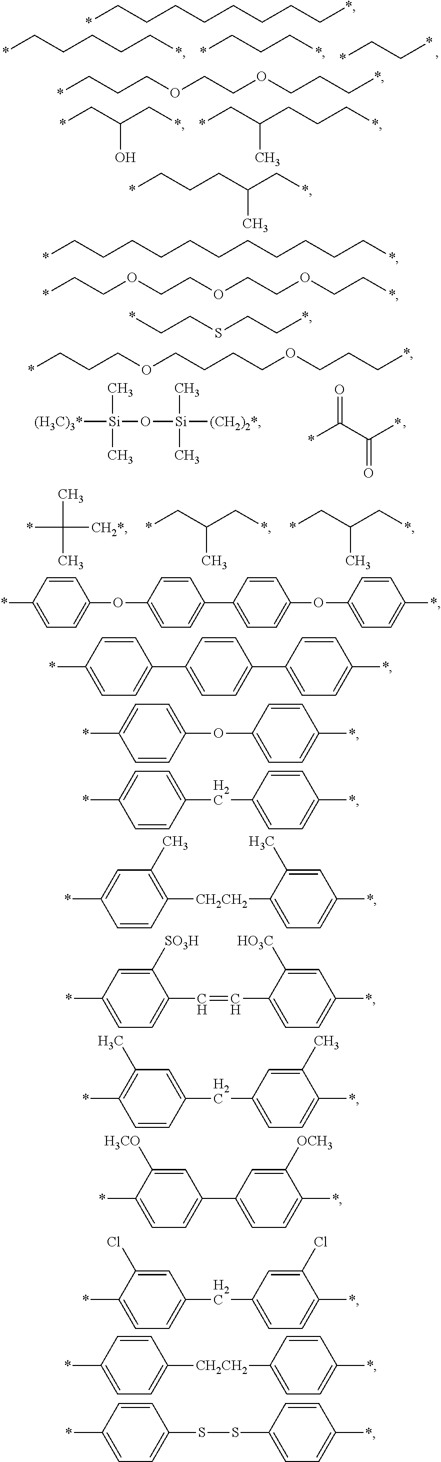

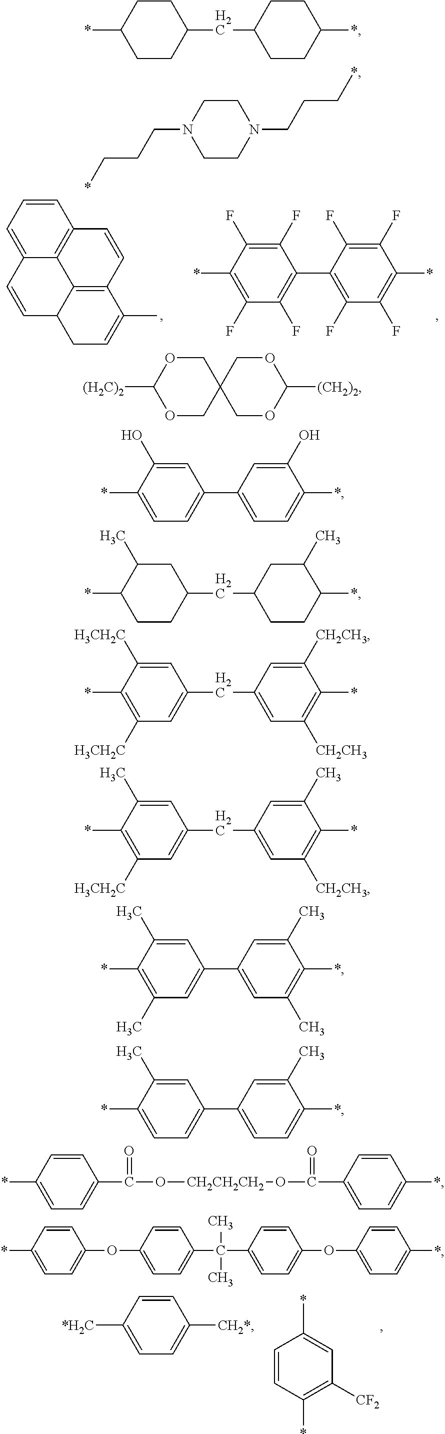

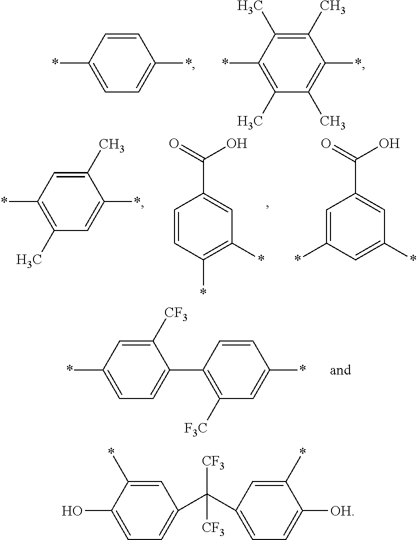

In an aspect of the present invention, the stirring speed in step b) may be 210 to 700 rpm.

In a specific aspect of the present invention, the stirring speed in step b) may be 300 to 500 rpm.

In an aspect of the present invention, the stirring time in step b) may be 5 minutes to 5 hours.

In an aspect of the present invention, the temperature in step b) is 150° C. to 400° C.

In an aspect of the present invention, the pressure in step b) is 10 to 300 bar.

In an aspect of the present invention, a polyimide powder produced by the production method is provided, and the polyimide powder can be manufactured into a molded article by being sintered at a temperature of 100° C. to 550° C. for 1 hour to 5 hours.

In an aspect of the present invention, the polyimide powder may have a particle size D50 of 15 μm or less.

In a specific aspect of the present invention, the polyimide powder may have a particle size D50 of 10 μm or less.

In an aspect of the present invention, the polyimide powder may have a particle size D99 of 150 μm or less.

In a specific aspect of the present invention, the polyimide powder may have a particle size D99 of 120 μm or less.

In an aspect of the present invention, the polyimide powder can be manufactured into a molded article having a tensile strength of 50 Mpa or more.

### Advantageous Effects of Invention

The polyimide powder and method for producing the same according to the present invention have advantages that the particle size can be easily controlled without additional processes by controlling the stirring speed in the water-based polymerization process, and thus the dispersibility and the mechanical properties during the manufacture of molded articles are improved.

### DESCRIPTION OF EMBODIMENTS

The present invention relates to a method for producing a polyimide powder, which includes a) preparing a dispersion by dispersing a dianhydride and a diamine in distilled water; and b) introducing the dispersion of step a) into a reactor and conducting the reaction at a stirring speed of 300 to 500 rpm under temperature and pressure conditions.

### EMBODIMENTS

Hereinafter, the present invention will be described in detail.

The present invention relates to a method for producing a polyimide powder, which includes a) preparing a dispersion by dispersing a dianhydride and a diamine in distilled water; and b) introducing the dispersion of step a) into a reactor and conducting the reaction at a stirring speed of more than 200 rpm under temperature and pressure conditions.

The present invention also relates to a polyimide powder produced by the production method.

The present invention also relates to a polyimide molded article manufactured by sintering the polyimide powder.

In the present invention, it is possible to produce a polyimide powder by a shortened process since distilled water is used as a solvent, and deterioration in mechanical properties do not occur after the residual solvent is removed since a waste solvent is not generated after the polyimide powder is produced.

In the present invention, the distilled water does not mean only distilled water in the literal sense, but water in any state such as deionized water and tap water may be used in addition to distilled water. In addition, the amount of distilled water may be appropriately adjusted depending on the amounts of dianhydride and diamine.

In an aspect of the present invention, a polyamic acid may be produced in step a) using 100 parts by weight of a dianhydride compound, 80 to 120 parts by weight of a diamine, and 1000 to 1200 parts by weight of a mixed solvent based on the dianhydride compound.

In an aspect of the present invention, the dianhydride in step a) may be a dianhydride represented by the following Chemical Formula 1.

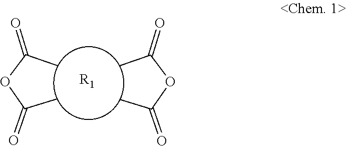

R₁ in Chemical Formula 1 is selected from the group consisting of the following chemical structures:

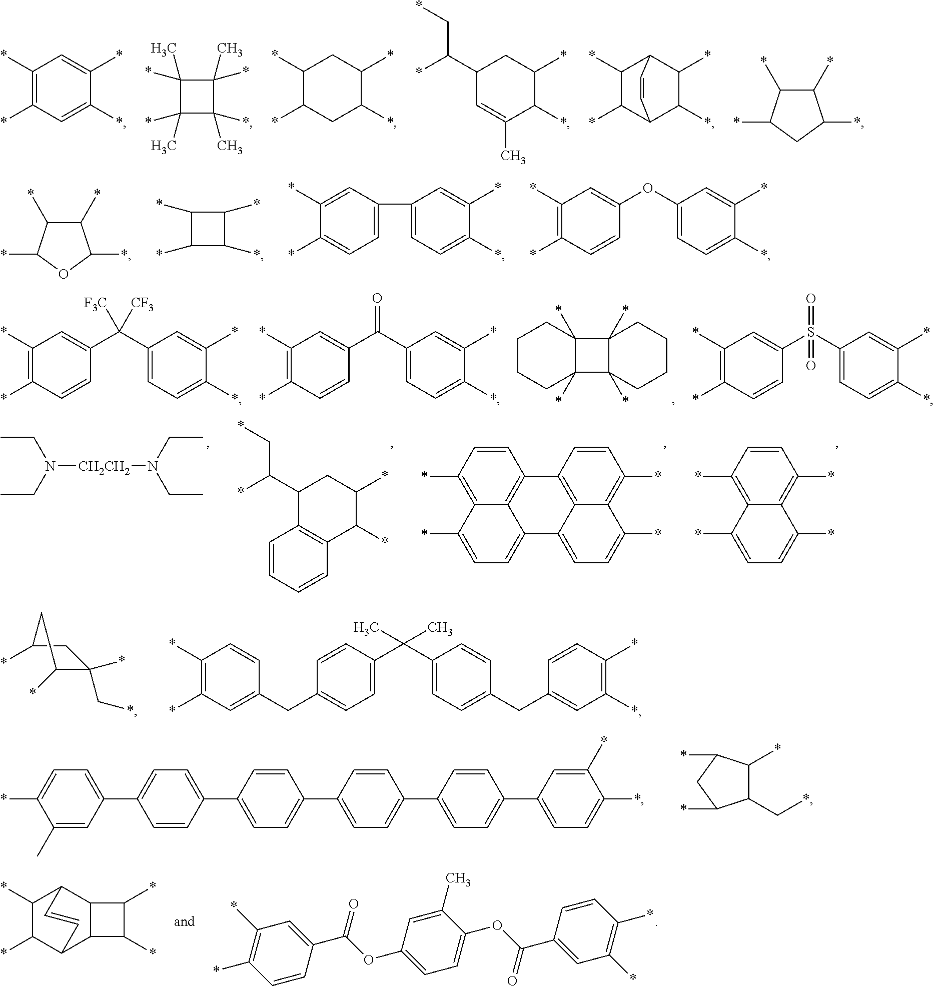

In an aspect of the present invention, the diamine in step a) may be a diamine represented by the following Chemical Formula 2.

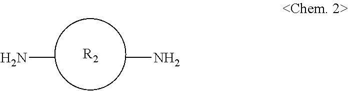

R₂ in Chemical Formula 2 is selected from the group consisting of the following chemical structures:

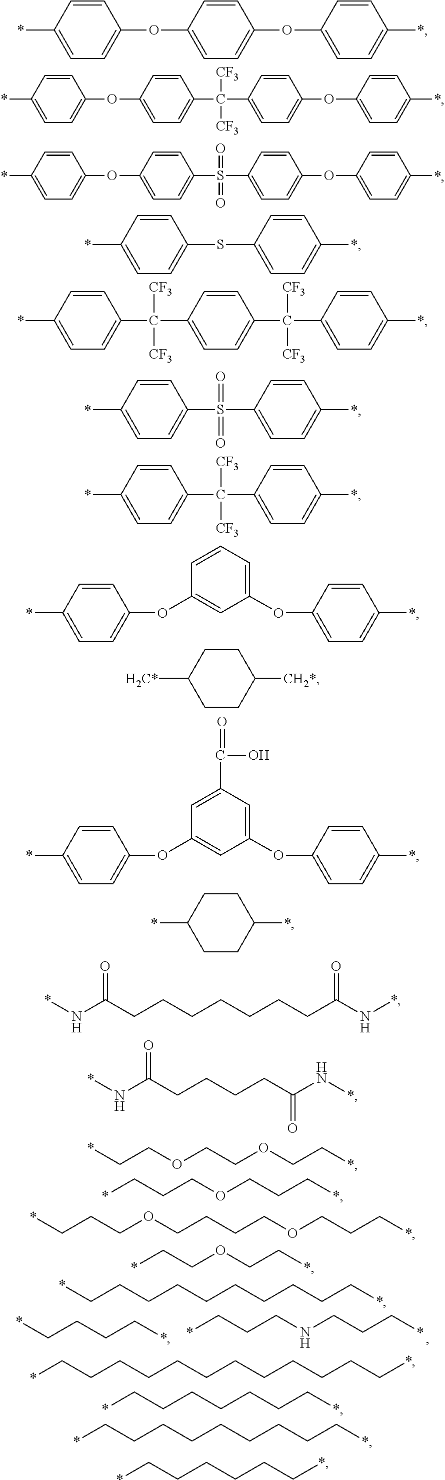

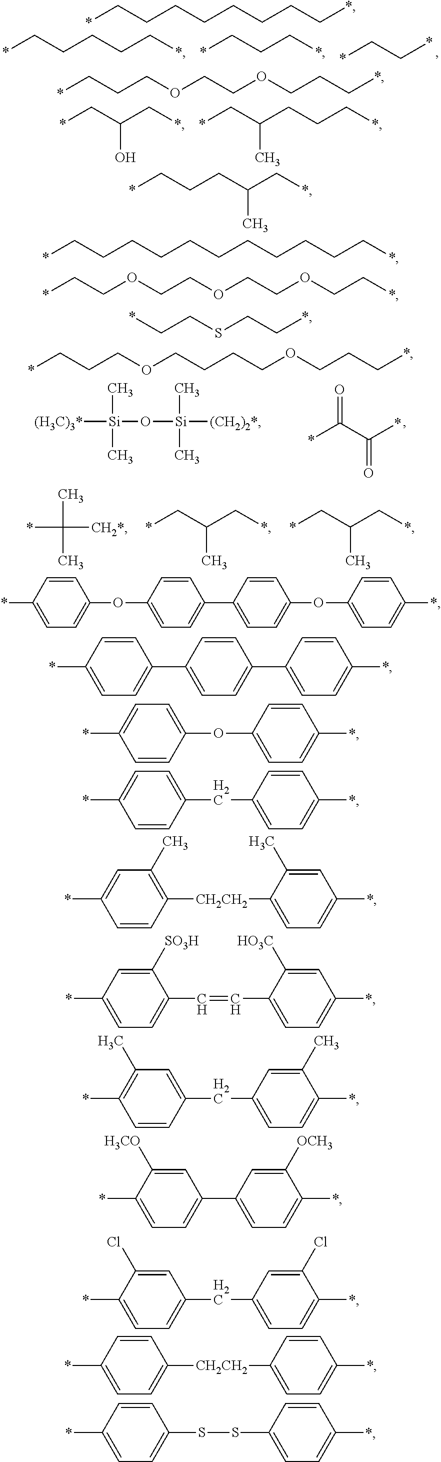

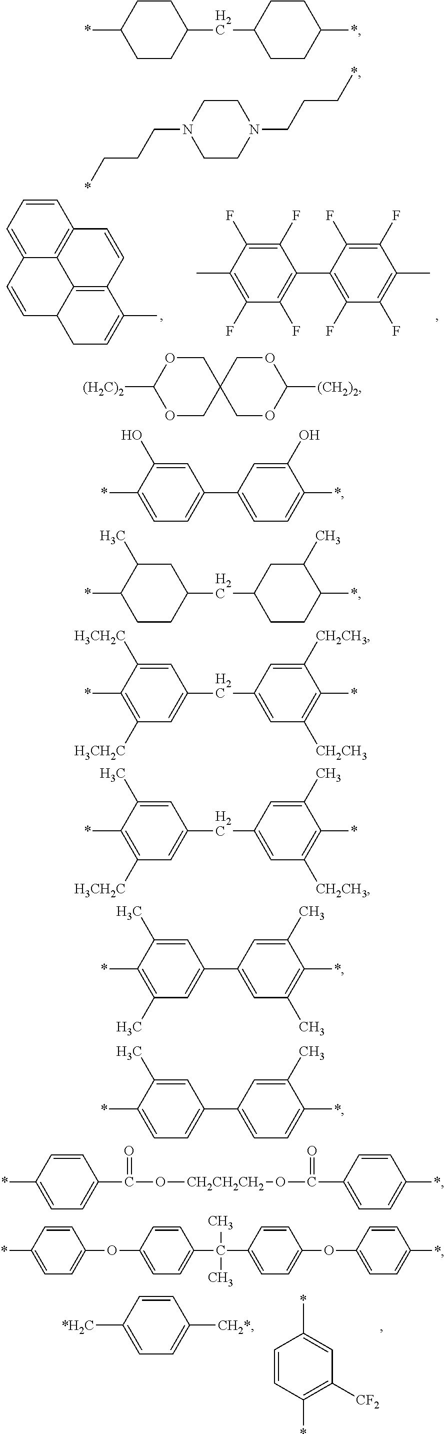

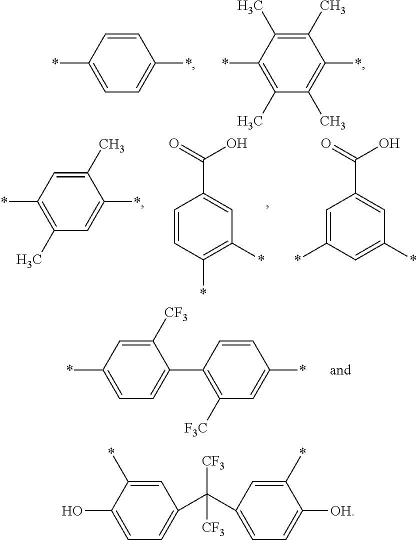

In an aspect of the present invention, the stirring speed in step b) may be 210 to 700 rpm. More specifically, the stirring speed may be 220 to 680 rpm, 230 to 660 rpm, 240 to 640 rpm, 250 to 620 rpm, 255 to 600 rpm, 260 to 580 rpm, 265 to 560 rpm, 270 to 550 rpm, 275 to 540 rpm, 280 to 530 rpm, 285 to 520 rpm, 290 to 510 rpm, or 300 to 500 rpm.

In the present invention, the particle size can be decreased by controlling the stirring speed in the process of imidization to produce a polyimide powder. In addition, there is an advantage of favorable configuration in that it is possible to control the particle size and improve the mechanical properties through the control of stirring speed without separate additional processes.

In an aspect of the present invention, the stirring time in step b) may be 5 minutes to 5 hours. More specifically, the stirring time may be 10 minutes to 5 hours, 30 minutes to 4.5 hours, 45 minutes to 4.5 hours, 1 hour to 4 hours, 1.5 hours to 4 hours, or 2 hours to 4 hours.

In an aspect of the present invention, the temperature in step b) may be 150° C. to 400° C. Specifically, the temperature in step b) may be 160° C. to 250° C., 170° C. to 240° C., or 180° C. to 220° C. The reaction rate may be excessively decreased when the reaction temperature is less than 150° C., and the thermal decomposition of monomer or polymer may proceed when the reaction temperature exceeds 400° C.

In an aspect of the present invention, the pressure in step b) may be 10 to 300 bar. Specifically, the pressure in step b) may be 10 to 300 bar, 10 to 100 bar, or 10 to 80 bar. It is difficult to control the reactivity when the reaction pressure is less than 10 bar, and it may be difficult to obtain a high molecular weight polyimide powder when the reaction pressure exceeds 300 bar.

In the present invention, a step of performing filtration and drying may be further included after step b) to produce a polyimide powder.

The present invention provides a polyimide powder produced by the production method.

The polyimide powder produced according to an embodiment of the present invention may be a wholly aromatic polyimide, a partially cycloaliphatic polyimide, or a wholly cycloaliphatic polyimide. However, the polyimide powder produced by the production method according to the present invention has excellent effects of having dispersibility and improved mechanical properties in a case where the polyimide powder is wholly aromatic as well.

In an aspect of the present invention, the polyimide powder can be manufactured into a molded article by being sintered at a temperature of 100° C. to 550° C. for 1 hour to 5 hours.

In an aspect of the present invention, the polyimide powder has a particle size D50 of 15 μm or less. More specifically, the polyimide powder may have a particle size D50 of 14 μm or less, 13 μm or less, 12 μm or less, 11 μm or less, or 10 μm or less.

In an aspect of the present invention, the polyimide powder has a particle size D99 of 150 μm or less. More specifically, the polyimide powder may have a particle size D99 of 145 μm or less, 140 μm or less, 135 μm or less, 130 μm or less, 125 μm or less, 120 μm or less, 115 μm or less, or 110 μm or less.

In the present invention, the D50 and D99 requirements can be simultaneously satisfied, and this indicates that the particle size of the produced polyimide powder is significantly decreased. As the particle size is controlled, dispersibility is exhibited, and it may be thus easy to manufacture molded articles.

In an aspect of the present invention, the polyimide powder can be manufactured into a molded article having a tensile strength of 50 Mpa or more.

The polyimide powder produced according to an embodiment of the present invention can be manufactured into a molded article through a compression molding, injection molding, slush molding, blow molding, extrusion molding or spinning method including the sintering step.

The polyimide powder produced according to an embodiment of the present invention has improved moldability and tensile strength, and can be utilized in a wide range of industrial fields such as aerospace, aviation, electric/electronic, semiconductors, transparent/flexible displays, liquid crystal alignment films, motor vehicles, precision instruments, packaging, medical materials, separators, fuel cells and secondary batteries.

### EXAMPLES

Hereinafter, the method for producing a polyimide powder according to the present invention and the physical properties of the polyimide powder produced through the production method will be described with reference to Examples. However, the present invention is not limited by the following Examples.

### <Example 1> Production of Wholly Aromatic Polyimide Powder

After 200 mL of distilled water was introduced into a pressure reactor, 21.13 g of 4,4′-oxydianiline (ODA) and 22.6 g of pyromellitic dianhydride (PMDA) were dispersed. After that, the dispersion was transferred to a pressure reactor equipped with a stirrer, a nitrogen injection device, and a temperature controller, the inside of the pressure reactor was purged with nitrogen gas, the temperature and pressure conditions of the pressure reactor were adjusted to 190° C. and 18 bar, respectively, and then stirring was performed at a speed of 500 rpm for 3 hours, followed by filtration and drying, thereby producing a polyimide powder.

### <Example 2> Production of Wholly Aromatic Polyimide Powder

A polyimide powder was produced in the same manner as in Example 1 except that the stirring speed was set to 400 rpm.

### <Example 3> Production of Wholly Aromatic Polyimide Powder

A polyimide powder was produced in the same manner as in Example 1 except that the stirring speed was set to 300 rpm.

### <Comparative Example 1> Production of Wholly Aromatic Polyimide Powder at Different Stirring Speed

A polyimide powder was produced in the same manner as in Example 1 except that the stirring speed was set to 200 rpm.

### <Comparative Example 2> Production of Wholly Aromatic Polyimide Powder at Different Stirring Speed

A polyimide powder was produced in the same manner as in Example 1 except that the stirring speed was set to 200 rpm.

### <Comparative Example 3> Production of Wholly Aromatic Polyimide Powder at Different Stirring Speed

A polyimide powder was produced in the same manner as in Example 1 except that the stirring speed was set to 150 rpm.

<Evaluation>

The particle size of the polyimide powders produced in Examples 1 to 3 and Comparative Examples 1 to 3 was measured using SALD-2201 particle size analyzer manufactured by Shimadzu Corporation after the polyimide powder was dispersed in water, and the average particle diameter was determined.

2 g of each of the polyimide powders produced in Examples 1 to 3 and Comparative Examples 1 to 3 was compression molded at a pressure of 96000 psi using ASTM D1708 standard specimen mold, and then heated and sintered at 100° C. for 1 hour, at 250° C. for 1 hour, and at 450° C. for 1 hour in a nitrogen atmosphere to manufacture 10 specimens. The tensile strength of the specimens manufactured through the process was measured and shown in the following Table 1. The tensile strength of the specimens was measured in conformity with the ASTM D1708 standard using Instron 5564 UTM.

TABLE 1

| Stirring | | Tensile |
|---|---|---|
| speed | Particle size (μm) | strength |

| Item | (rpm) | D50 | D99.9 | (Mpa) |
|---|---|---|---|---|
| Example 1 | 500 | 3.3 | 37 | 68 |
| Example 2 | 400 | 4.6 | 49 | 60 |
| Example 3 | 300 | 7.4 | 106 | 53 |
| Comparative | 200 | 30.6 | 202 | 48 |
| Example 1 | | | | |
| Comparative | 200 | 32.5 | 252 | 49 |
| Example 2 | | | | |
| Comparative | 150 | 42.5 | 309 | 46 |
| Example 3 | | | | |

As shown in Table 1, D50 is 3.3 μm, 4.6 μm, and 7.4 μm, respectively, and D99.9 is 37 μm, 49 μm, and 106 μm, respectively, when the particle size of the polyimide powders produced in Examples 1 to 3 of the present invention is measured, and it has been confirmed that the particle size is significantly decreased. In the case of Comparative Example 1, Comparative Example 2, and Comparative Example 3 where polyimide powders are produced by varying the stirring speed, D50 is 30.6 μm, 32.5 μm, and 42.5 μm, respectively, and D99.9 is 202 μm, 252 μm, and 309 μm, respectively, this means that the particle size is 4 times or more the particle size in Examples 1 to 3, and it has been confirmed that the particle size is significantly large.

As shown in Table 1, in the case of Comparative Examples 1 to 3, the tensile strength of all the molded articles is less than 50 Mpa, and it has been confirmed that deterioration in mechanical strength occurs.

Hence, in the method for producing a polyimide powder according to the present invention, it has been found that the particle size of polyimide powder can be controlled more simply by controlling the stirring speed in the polyimide powder production step. In addition, as the particle size of polyimide powder is controlled, the polyimide powder has excellent properties to be manufactured into a molded article having excellent mechanical strength. In addition, the efficiency in the production process is high since the reaction temperature is low and the reaction time is short, and the production method is environmentally friendly and has the effect of cost reduction since water is used as a reaction solvent.

### INDUSTRIAL APPLICABILITY

The method for producing a polyimide powder according to the present invention can provide a production method capable of controlling the particle size of powder by controlling the stirring speed. The production method is also effective in manufacturing a molded article having excellent mechanical strength as the particle size of polyimide powder is controlled.

1. A method for producing a polyimide powder, the method comprising:
a) preparing a dispersion by dispersing a dianhydride and a diamine in distilled water; and
b) introducing the dispersion of step a) into a reactor and conducting a reaction at a stirring speed of more than 200 rpm under temperature and pressure conditions.

2. The method for producing a polyimide powder according to claim 1,
wherein the dianhydride in step a) is a dianhydride represented by the following Chemical Formula 1: 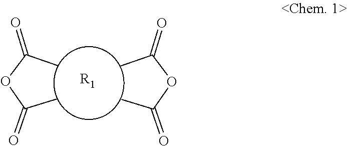
and in Chemical Formula 1, R₁ is selected from the group consisting of the following chemical structures

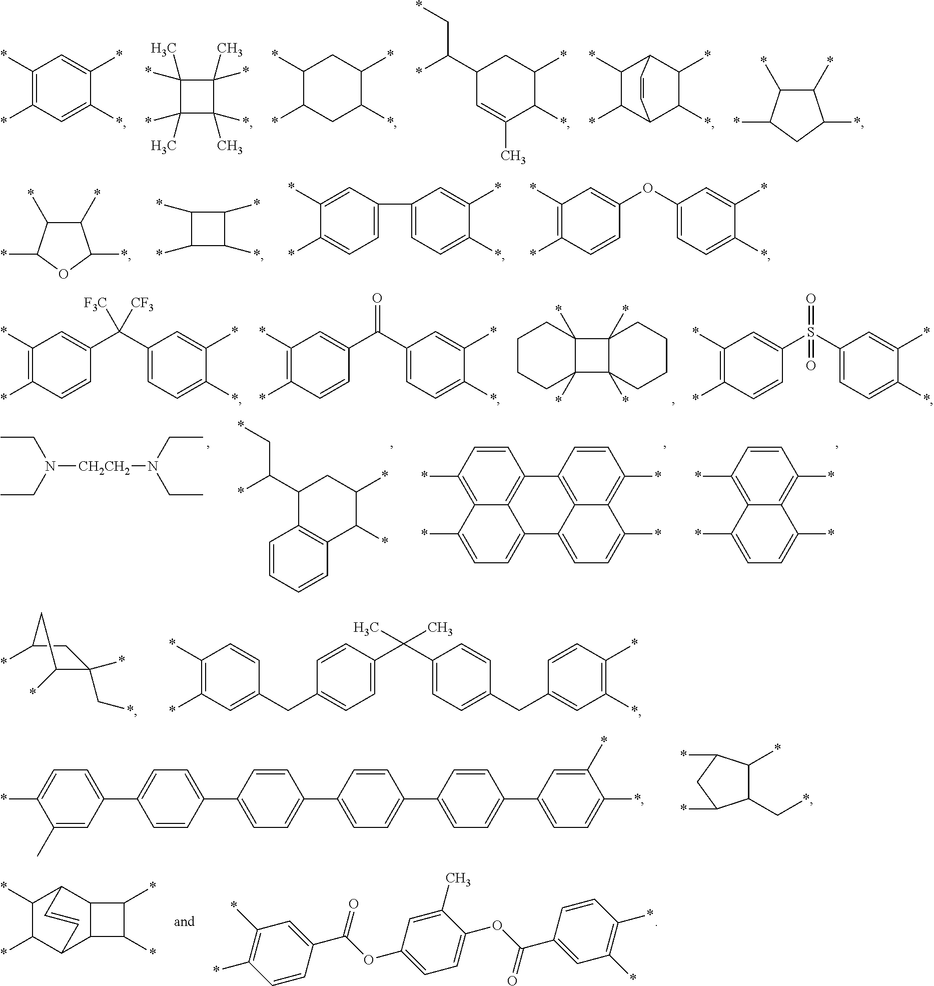

3. The method for producing a polyimide powder according to claim 1,
wherein the diamine in step a) is a diamine represented by the following Chemical Formula 2: 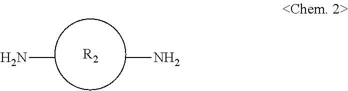
and in Chemical Formula 2, R₂ is selected from the group consisting of the following chemical structures

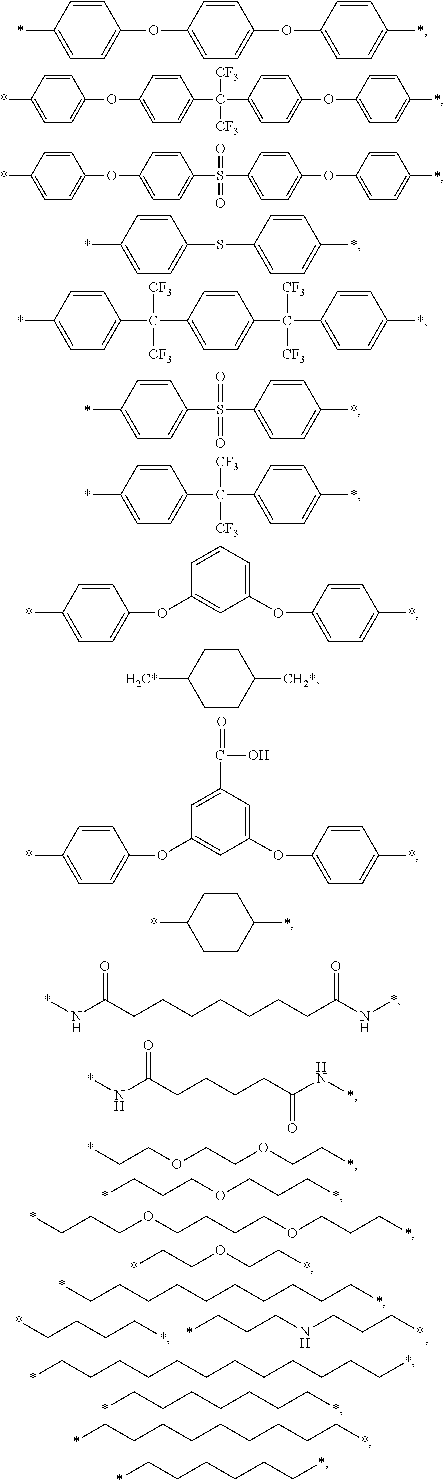

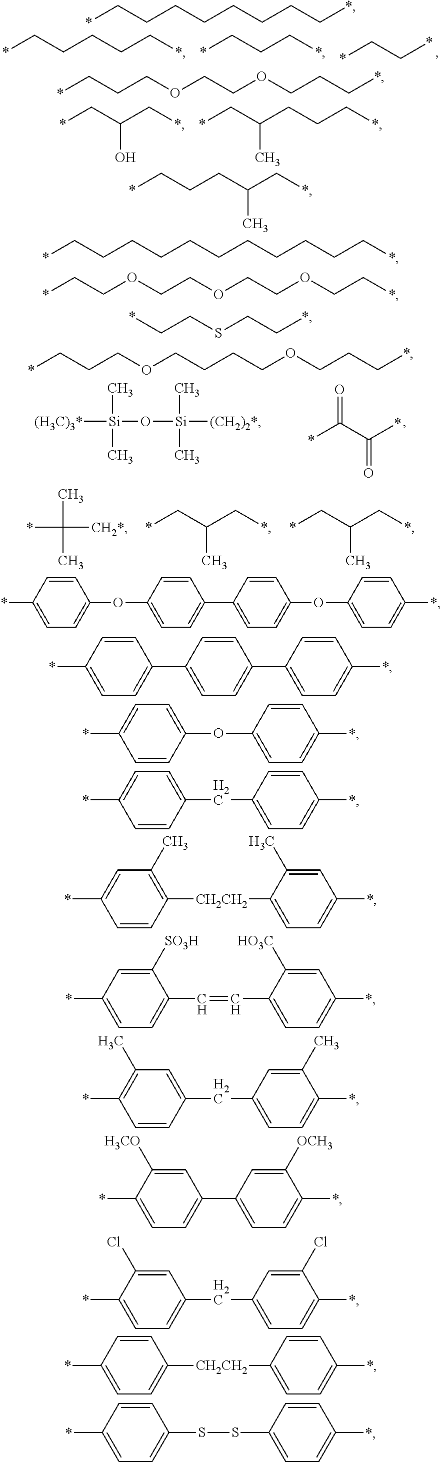

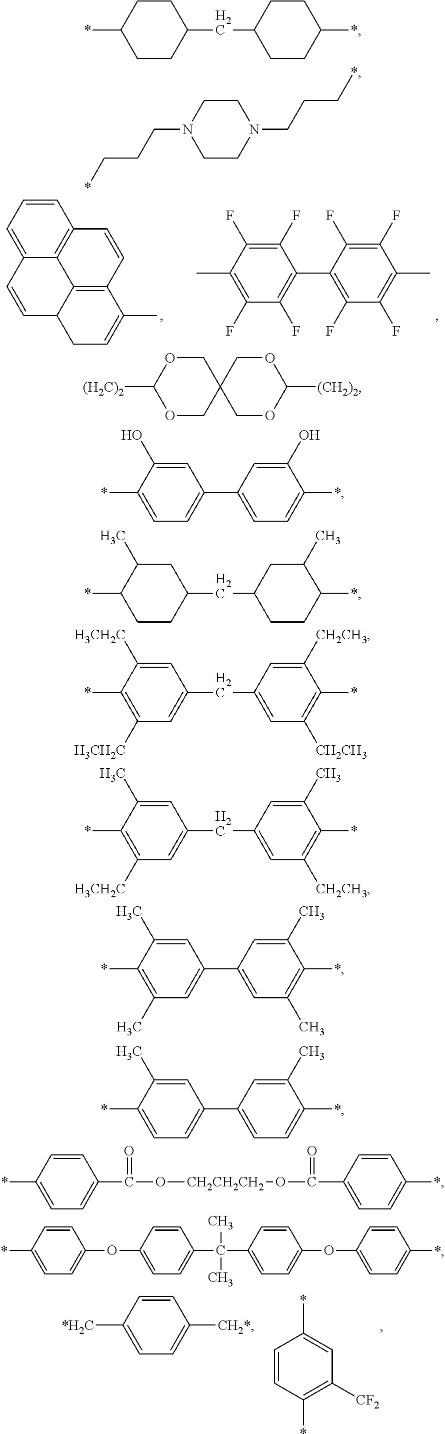

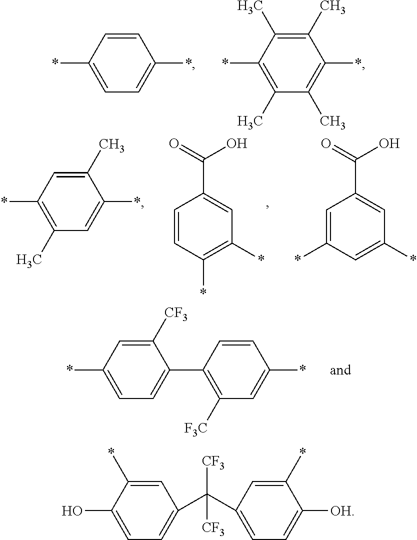

4. The method for producing a polyimide powder according to claim 1,
wherein the stirring speed in step b) is 210 to 700 rpm.

5. The method for producing a polyimide powder according to claim 1,
wherein the stirring speed in step b) is 300 to 500 rpm.

6. The method for producing a polyimide powder according to claim 1,
wherein a stirring time in step b) is 5 minutes to 5 hours.

7. The method for producing a polyimide powder according to claim 1,
wherein a temperature in step b) is 150° C. to 400° C.

8. The method for producing a polyimide powder according to claim 1,
wherein a pressure in step b) is 10 to 300 bar.

9. A polyimide powder produced by the production method according to claim 1.

10. The polyimide powder according to claim 9,
wherein the polyimide powder has a particle size D50 of 15 μm or less.

11. The polyimide powder according to claim 9,
wherein the polyimide powder has a particle size D50 of 10 μm or less.

12. The polyimide powder according to claim 9,
wherein the polyimide powder has a particle size D99 of 150 μm or less.

13. The polyimide powder according to claim 9,
wherein the polyimide powder has a particle size D99 of 120 μm or less.

14. The polyimide powder according to claim 9,
wherein the polyimide powder can be manufactured into a molded article by being sintered at a temperature of 100° C. to 550° C. for 1 hour to 5 hours.

15. The polyimide powder according to claim 9,
wherein the polyimide powder can be manufactured into a molded article having a tensile strength of 50 Mpa or more.

16. A polyimide molded article manufactured by sintering the polyimide powder according to claim 9.
